(19) United States
(12) Patent Application Publication
(10) Pub. No.: US 2015/0102924 A1
(43) Pub. Date: Apr. 16, 2015

(54) Volume/Vibrate Overriding Feature Of Alert System For Mobile Devices

(71) Applicants: Richard L. Soloway, Amityville, NY (US); Michael Carrieri, Amityville, NY (US)

(72) Inventors: Richard L. Soloway, Amityville, NY (US); Michael Carrieri, Amityville, NY (US)

(21) Appl. No.: 14/053,967

(22) Filed: Oct. 15, 2013

(51) Int. Cl. G08B 25/00; G08B 25/10

(52) U.S. Cl. CPC G08B 25/008; G08B 25/10
USPC 340/539.11

(57) ABSTRACT

The invention relates generally to a home security alarm system and more specifically to a home security alarm app once triggered will override primary mobile device's sound setting and determine if a full volume (or higher volume than current setting of device) alarm sound is needed to alert the end user of a problem situation. The home security alarm app is linked with the house security alarm. Once the house security alarm is set off, the home security alarm app will also be set off to alert the user of a particular problem with the building that is being monitored.

### BACKGROUND OF THE INVENTION

1. Field of the Invention

The invention relates generally to a security system and more specifically to a security alert application (“app” hereinafter) on a mobile device which once triggered will override primary mobile device sound setting and turn on sound at a desired user level—said level being adjusted from low volume up to a full volume or activate vibrate alert. The security alert app is linked with a home/office security system alarm. Once the home/office security system alarm is set off, the security alert app will also be set off providing the user with the required GUI and/or interface to visually alert the user of a particular problem with the premises that are being monitored and allow them to take action.

2. Description of Related Art

Home/Office security systems for providing home/office security and personal safety are known in the prior art because home/office security and personal safety are major concerns for individuals and corporations alike.

More specifically, by way of example, U.S. Pat. No. 6,661,340 B1 to Saylor et al. discloses a personal security network where an individual's system or systems of security devices may be connected to a central security network. The central security network may monitor a system's status and alert the individual when an alert situation occurs.

U.S. Pat. No. 6,690,411 B2 to Naidoo et al. discloses a system and method for enabling a central station to accurately verify in real-time whether an alarm signal generated by a security base station is a false alarm, and for enabling remote users to securely access features of the security base station.

U.S. Pat. No. 7,561,019 B2 to Sasakura et al. discloses a security system capable of safely performing home device state check or operation. In the security system, a mobile telephone module of a mobile telephone transmits data (call signal) to home device modules such as a door lock and home electric appliances. In response to this call, the home device module returns a home device ID to the mobile telephone module.

While prior art has ways of keeping track of the office or home security system alarm with a mobile device, currently available home/office security system mobile device apps provide real time alerts mainly in the form of text messages or emails which are easy to miss, and if the volume is turned off, there is no mechanism to override the currently set volume setting and put the volume on maximum.

Our system provides an intuitive approach to end user alerting. Not only will the end user be able to adjust their mobile device to alert them at any desired volume from low to high or vibrate, the system itself can detect various levels of emergency and override mobile device settings to signal alarms at a more effective level based on the degree of urgency. Therein, even when the phone has been sent to low volume by the end user when a high level emergency occurs the application can override said setting and produce a high level alarm sound on the mobile device.

Since there is a strong need for the user of a mobile device to be alerted at once when there is an alarm set off at a building that is monitored with an alarm system, there is also the need for an alerting system that will generate a sound alert to the mobile device users at a volume level that is desired by said user instead of a text message alert on user's mobile device. This will wake a user if said user is asleep or alert said user when viewing of his or her mobile device is not at hand. Sometimes, people may turn off their mobile device speaker, put said device on vibrate, or turn down sound volume to a very soft level, therefore, it is necessary to have an application system wherein a full volume overriding feature exists for the alerting system that one may install on his or her mobile device.

Effectively, the system described herein has an intuitive feature whereby it can sound alerts at two varying levels. One level is based upon the end user settings of the system and the other level is based upon the systems analysis of the critical issue at hand and will therein determine the proper volume level for alerting the end user. For example, if the end user has turned their cell phone to mute during sleep time, the system will be able to override this mute level and produce a full volume sound alarm to alert the end user of a elevated or high level security alarm breach issue that is being monitored by the system.

### SUMMARY OF THE INVENTION

It is an object of the present invention to provide a mobile device with a security alert app. Said security alert app has unique features that allow for varying levels of sounds to be produced based upon two factors—
1. the level determined for alerts set by the electronic device end user;
and
2. levels determined by the system itself which can override end user set levels depending upon the degree of urgency to alert said end user.

For example, if the system is monitoring an end user's home there are various levels of emergencies that the homeowner would need to be alerted to. Each emergency can be graded with a level of severity and based upon said level of severity the system can determine what level of sound output is required to alert the end user.

If there is a power outage a lower level of alarm could be sounded than if there is a security break in at the building or home being monitored. Therein, said system will either agree with or disagree with the electronic devices current settings and based upon its own pre-determined settings create sound alarming volume as required—lower sound for less severe matters; higher sound levels for greater severe matters.

Therefore, another object of the present invention is to provide a mobile device security alert app that will bypass any diminished sound and put the mobile device's volume at a full level or varying level based upon the severity of the matter at hand

Another object of the present invention is to provide a mobile device security alert app that will bypass a turned off screen to turn itself on when needed.

Another object of the present invention is to provide a mobile device security alert app where the app will be in off mode but a security system breach signal to the mobile device will turn on the app when needed. This will conserve battery life of the mobile device.

Yet another object of the present invention is to provide a home/office security system that includes a security alert app on a mobile device which can turn on said mobile device's screen that's originally turned off, override the mobile device's setting and give off a loud or increased volume from current phone setting alerting tone to alert mobile device's user when receiving digital signal from the security system.

In an exemplary embodiment of the present invention, there is disclosed a security alert app that can give off alternating volume from low to loud alerting tones to alert mobile device's user when receiving digital signal from the security system. Even if the mobile device's ringer setting is lowered or turned off at night—where there is an emergency the security alert app can override the mobile device setting and turn the volume to a varying level based upon the severity of the matter at hand up to a full volume alert level of sound.

A mobile device incorporating an alarm, such as the iPhone™, incorporates a mechanical or software switch that toggles between speaker audio and silencing the speaker. The alarm can override the switch's silent setting for all of the alarm's audio, which includes the siren and network status announcements. This is prior art known in the field.

The present invention utilizes similar technology to override the mobile device setting and turn the volume to varying levels based upon the level of severity of the emergency being reported—from low to maximum volume.

The full volume security alerting app of the present invention is triggered when an alarm system that is being monitored by the software of the premises is activated. The security alert app of the present invention is able to:

1. turn on a mobile device's screen that's originally turned off, override the mobile device's setting and give off varying levels of loud alerting tones to alert the mobile device's user

2. or start up an application when receiving digital signal from the security system. The user can also immediately see alarm zones that got tripped, the type of emergency and more without pushing any buttons on the mobile device. It is of great use at night without fumbling to find the mobile device keys to push for info in the dark.

The security alert app of the present invention can also interact with another security system app which can only send text messages or emails. When receiving signals sent from the other security system app, the security alert app of the present invention can recognize the signals and then override the mobile device settings to produce a full or preset volume alerting tone to alert the mobile device's user. The system is able to determine the level of severity of the situation at hand and produce a sound level that is appropriate with the situation being reported. The more severe the situation, the louder the sound.

Some of the traditional features of our security alert app for the mobile device include the following:

1. the mobile device can act as a keypad for the alarm system.

2. the security alert app of the present invention will be turned on or started and turned on by the alert signals sent from the security system without regard to weather the mobile device is on or off. The mobile device's screen that was originally turned off will be turned on and the screen locking feature on the mobile device will be bypassed. In other words the app can remain dormant when there is no need to give off an alarm to the user. This will allow for the battery of the mobile device not to be drained until it is needed. The only time the app will be active and drain battery life is when it is giving off an alarm to alert the user of a problem with the building that has the physical alarm system installed therein.

Most electronic devices allow for independent application systems that enhance the device's usages. However, they do not allow for the ability to programmatically startup and or launch said device when said device is “off” based upon an incoming message sent to said device.

Said system described herein allows for a message to be sent to a mobile device and instruct said mobile device to turn on or start up a specific application that has been installed by the end user within the device itself. This feature allows for remote startup/launch of the application independent of the status of the electronic device itself. If the electronic device is therefore in an off state, the application would turn on the device and activate alarm alerting features as needed.

Depending upon the mobile device that is used will determine how implementation of said invention will interact with the mobile device's operating system. Cooperation of the mobile device developer is critical.

For example with an Apple™ related device there are two issues that would be addressed.

First off Apple™ must allow this application to have access to the sound controls via its API.

With option 1, Apple™ would need to allow the development of an application that can run in the background of its device in the same fashion that music apps are able to run in the background. This art is well understood within the industry. The invention described herein can run in the background of said mobile device and maintain or receive a TCP/IP socket connection, UDP or any other type of electronic based communication which would cause the system to execute preprogrammed functionality such as alarm beeping and sound generation.

Said mobile device produced by Apple™ would also allow the invention system application to become the active system application in the foreground so that the keypad could be displayed as needed.

With option 2, Apple™ needs to develop a protocol that allows an SMS or other type of message—technology which is well understood within the industry—to start the alarm volume control system that is already resident on the phone and grant it the ability to pass it's parameters throughout.

This allowing of the business method functionality by said operating system is independent of the system described herein but represents a key point as to how said invention can control key features within said electronic handheld devices.

With the access to the operating system installed in a mobile device other features also become possible. Such system could, for example, have the ability to override an application that is already running and become the primary active system at any given time. This would enable the alarm feature to function at any given time no matter what other applications are running when an alarm signal needs to be conveyed to the end user.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a flow chart which demonstrates a method of implementing a security alert app on a mobile device according to one embodiment of the present invention.

FIG. 2 is a block diagram which illustrates key components of the security alert app for a mobile device according to one embodiment of the present invention.

FIG. 3 is a graphical representation of a home/office security system having wireless connection with mobile devices and a security alert app on mobile devices according to one embodiment of the present invention.

FIG. 4 is a graphical representation showing another home/office security system provider utilizing the security alert app of the present invention.

### DESCRIPTION OF THE PREFERRED EMBODIMENT

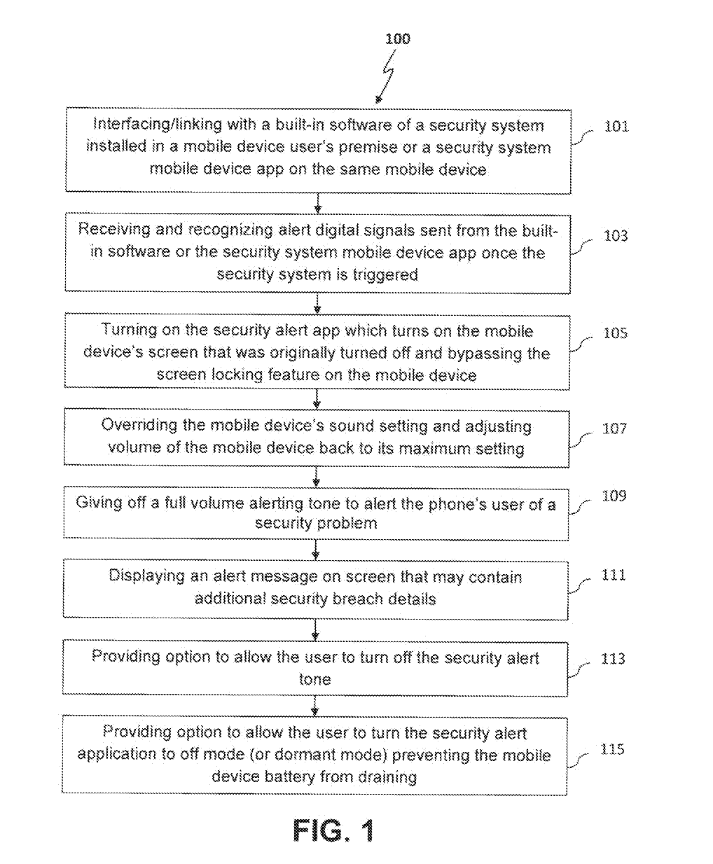

Referring to FIG. 1, there is disclosed a flow chart which demonstrates a method of implementing a security alert app on a mobile device according to one embodiment of the present invention.

A method 100 of implementing a security alert app on a mobile device, the method comprises the following steps.

First, the security alert app of the present invention needs to interface and/or link with a built-in software of a security system installed in a mobile device user's premise, at block 101. Alternatively, the security alert app can interface and/or link with a traditional security system app on the same mobile device which has interface and/or link with the security system installed in the mobile device user's premise but normally sends only text message to alert mobile device user, at block 101. When the security system installed in the mobile device user's premise gets breach (triggered), the built-in software of the security system sends out digital alert signals. The security alert app of the present invention receives and recognizes the digital alert signals sent by the built-in software, at block 103. Then the signal from the security system turns on the app which turns on the mobile device's screen that was originally turned off and bypasses the screen locking feature on the mobile device, at block 105.

The app overrides the mobile device's sound setting and adjusts the volume of the mobile device back to its maximum setting or preset volume at block 107 and gives off a preset volume alerting tone to alert the mobile device's user of a security problem at block 109. This volume level can either equal or be greater than the current device sound levels. Such volume determinate is based upon the level of severity of the matter at hand. If there is a need for a high level alert then the system can adjust the volume as loud as system determines is needed to send an alerting alarm. The app may further display an alert message on screen that may contain additional security breach details at block 111.

These security breach details may include but are not limited to alarm zones that got tripped or what type of emergency, electrical outage within a building, break in or damage to outer structure of a building, movement within structure, fire damage, water damage, temperature change. Said security breach details may be displayed on the screen as text or multimedia (image or video) messages. The app has options to allow the user to turn off the security alarm tone at block 113 or turn the security alert app to off mode to prevent the mobile device's battery from draining at block 115.

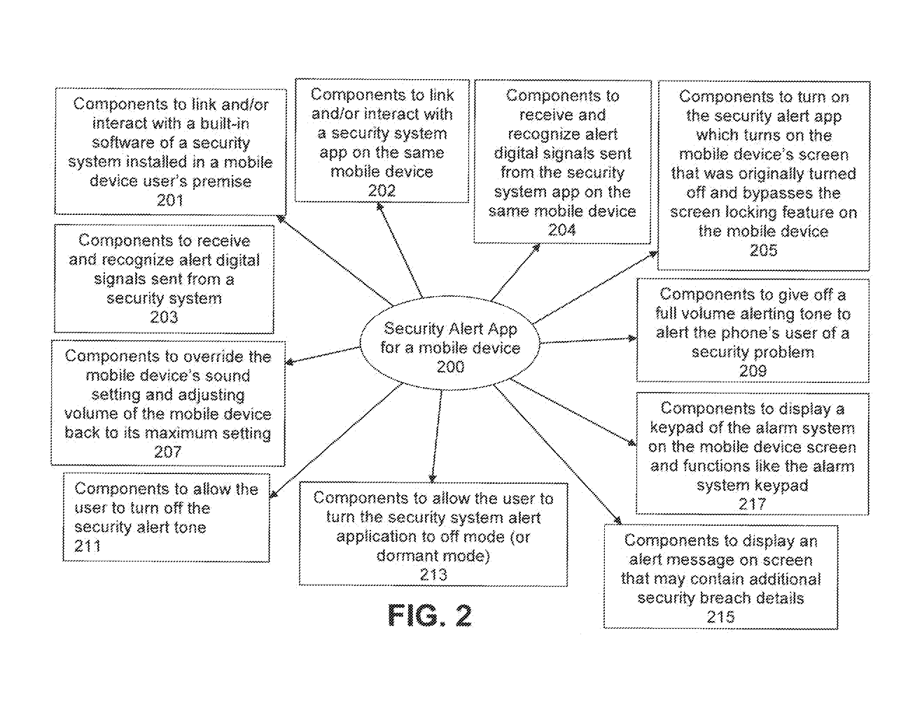

Referring to FIG. 2, there is disclosed a block diagram which illustrates key components of the security alert app 200 for a mobile device according to one embodiment of the present invention. The security alert app 200 of the present invention is a software app designed to run on mobile devices including smart phones, tablet computers and other mobile devices.

The security alert app 200 of the present invention comprises components 201 to link and/or interact with a built-in software of a security system installed in a mobile device user's premise and components 203 to receive and recognize digital alert signals from the built-in software of the security system once the security system installed in the mobile device user's premise is triggered. Alternatively, the app 200 can have components 202 link and/or interact with a security system mobile device app provided and designed for linking and/or interacting with the security system installed in the mobile device user's premise and components 204 to receive and recognize digital alert signals from the security system mobile device app once the security system installed in the mobile device user's premise is triggered.

The security alert app 200 further comprises components 205 to allow said signals from the security system to turn on the app 200 which turns on the mobile device's screen that was originally turned off and bypass the screen locking feature on the mobile device to eliminate the need to push any buttons on the mobile device); components 207 to override the mobile device's sound setting and adjusting volume of the mobile device back to its maximum setting; components 209 to give off a full volume alerting tone to alert the mobile device's user of a security problem; components 211 to allow the user to turn off the security alert tone; and components 213 to allow the user to turn the security system alert app to off mode (or dormant mode) preventing the mobile device battery from draining.

The security alert app 200 of the present invention may further comprises components 215 to display an alert message on screen that may contain additional security breach details, wherein said security breach details include alarm zones that got tripped or what type of emergency and said security breach details may be displayed as text or multimedia (image or video) messages.

The security alert app 200 of the present invention may further comprises components 217 to display a keypad of the alarm system on the mobile device screen and functions like the alarm system keypad.

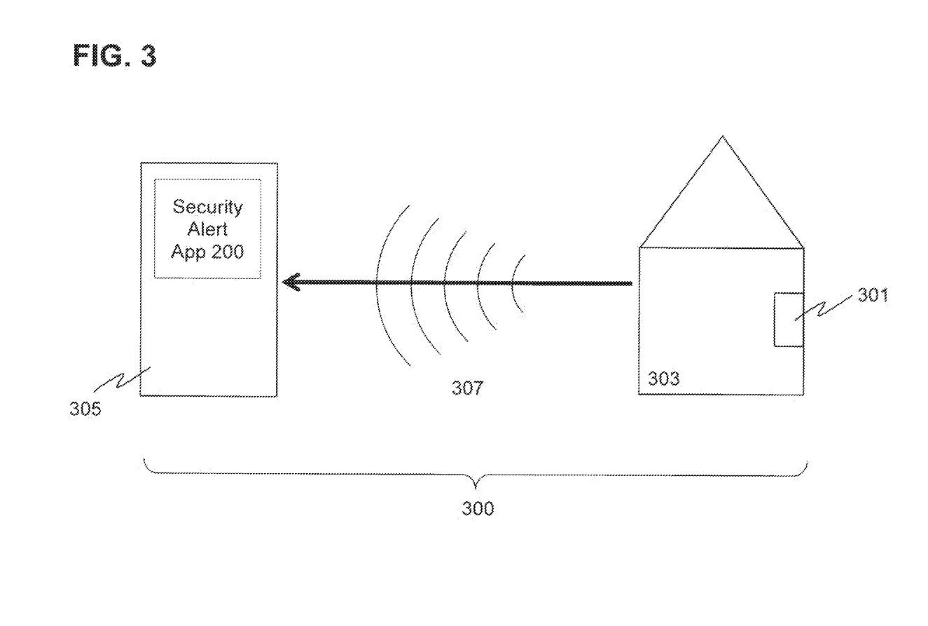

Referring to FIG. 3, there is disclosed a security system 300 which utilizes the security alert app 200 to alert the user through their mobile device.

The home/office security system 300 of the present invention comprises physical security system 301 installed in home and/or office premises which has software to detect and monitor the security of the premises 303 and has wireless connection with mobile devices 305; and a security alert app 200 on a mobile devices 305. When the security system 301 in the premise 303 is triggered, the home/office security system 301 sends digital alert signals 307 to the security alert app 200 on the mobile device 305.

The detailed construction and operation of the physical security system 301 and its software is well known in the art and is therefore not described herein. It is contemplated that any suitable currently available security system could work with the security alert app 200 of the present invention.

Said security alert app software 200 receives and recognizes when the alert digital signal 307 from said security system 301 arrives and said app software 200 can override certain mobile device features including but not limited to turning off the mute feature of the mobile device and making loud alerting tone for user to hear, turning off the screen saver of the mobile device and displaying alert message and images of security problems on screen for user to see.

Said security alert messages include detail information as to which alarm zones are breached or what type of emergency and may be displayed as text or multimedia (image or video) messages.

Said security alert app 200 in the home/office security system 300 can also display a keypad of the alarm system on the mobile device screen and functions like the alarm system keypad.

The security alert app 200 of the home/office security system 300 stays dormant in the off mode before receiving digital signals from the home/office security system to prevent the mobile device battery from draining.

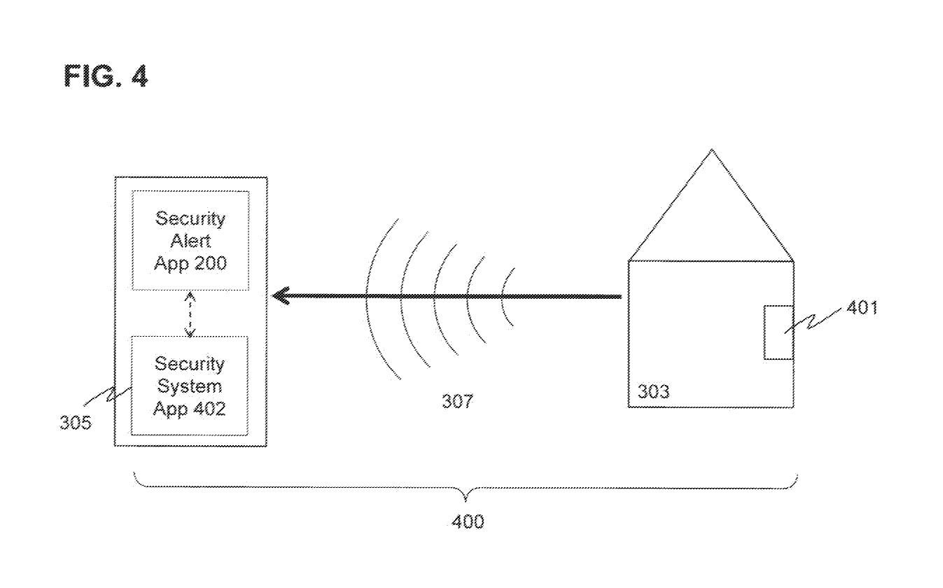

Alternatively in another embodiment 400 as shown in FIG. 4, the security alert app 200 of the present invention can work with other security system providers who sets up physical security system and software 401 and with our without an app 402 on the mobile device but only sends out text message or emails. These security system providers can utilize the security alert app 200 of the present invention to deliver loud audible alert tones to their subscribers even if the mobile device's sound is turned off.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A method of implementing a security alert app on a mobile device, the method comprising:
interfacing/linking with a built-in software of a security system installed in a mobile device user's premise;
receiving and recognizing digital alert signals from the built-in software of the security system once the security system installed in the mobile device user's premise is triggered;
turning on the security alert app which turns on the mobile device's screen that was originally turned off and bypass the screen locking feature on the mobile device;
overriding the mobile device's sound setting and adjusting volume of the mobile device up to its maximum or preset setting;
giving off a full volume or preset alerting tone to alert the mobile device's user of a security problem;
providing the user with the appropriate GUI and/or interface to visualize the alert being sent without having to touch or press additional buttons;
providing option to allow the user to turn off the security alert tone; and
providing option to allow the user to turn the security alert app to off mode (or dormant mode) preventing the mobile device battery from draining.

2. The method of claim 1, further comprising interfacing/linking with a security system mobile device app on the same mobile device which is designed to interface/link with the built-in software of the security system installed in the mobile device user's premise; and receiving and recognizing digital alert signals from the security system mobile device app once the security system installed in the mobile device user's premise is triggered.

3. The method of claim 1, further comprising displaying an alert message on screen that may contain additional security breach details.

4. The method of claim 3, wherein said security breach details include alarm zones that got tripped or what type of emergency.

5. The method of claim 4, wherein said security breach details may be displayed as text or multimedia (image or video) messages.

6. The method of claim 1, further comprising displaying a keypad of the alarm system on the mobile device screen and functions like the alarm system keypad.

7. A security alert app on a mobile device comprising:
components to link and/or interact with a built-in software of a security system installed in a mobile device user's premise;
components to receive and recognize digital alert signals from the built-in software of the security system once the security system installed in the mobile device user's premise is triggered;
components to turn on the security alert app which turns on the mobile device's screen that was originally turned off and bypass the screen locking feature on the mobile device;
components to override the mobile device's sound setting and adjusting volume of the mobile device up to its maximum setting;
components to give off a varying volume alerting tone to alert the mobile device's user of a security problem;
components to allow the user to turn off the security alert tone; and
components to allow the user to turn the security system alert app to off mode (or dormant mode) preventing the mobile device battery from draining.

8. The security alert app of claim 7, further comprising components to link and/or interact with a security system mobile device app provided and designed for linking and/or interacting with the security system installed in the mobile device user's premise; and components to receive and recognize digital alert signals from the security system mobile device app once the security system installed in the mobile device user's premise is triggered.

9. The security alert app of claim 7, further comprising components to display an alert message on screen that may contain additional security breach details.

10. The security alert app of claim 8, wherein said security breach details include alarm zones that got tripped or what type of emergency.

11. The security alert app of claim 9, wherein said security breach details may be displayed as text or multimedia (image or video) messages.

12. The security alert app of claim 7, further comprising components to display a keypad of the alarm system on the mobile device screen and functions like the alarm system keypad.

13. A home/office security system comprising:
a home/office security system with a cellular network and/or Wi-Fi connection/communication; and
a security alert App on a mobile device;
wherein the home/office security system sends digital signals to the security alert app on the mobile device when the security system is triggered;
wherein said security alert app software receives and recognizes when the digital alert signals from said security system arrives and said app software can override certain mobile device features including but not limited to turning off the mute feature of the mobile device and making loud alerting tone for user to hear, turning off the screensaver of the mobile device and displaying alert message and images of security problem on screen for user to see.

14. The home/office security system of claim 13, wherein said security alert messages include which alarm zones that got tripped or what type of emergency.

15. The home/office security system of claim 14, wherein said security alert messages may be displayed as text or multimedia (image or video) messages.

16. The home/office security system of claim 15, wherein said security alert app can display a keypad of the alarm system on the mobile device screen and functions like the alarm system keypad.

17. The home/office security system of claim 13, wherein the security alert app stays dormant in off mode before receiving digital signals from the home/office security system to prevent the mobile device battery from draining.
